(19) United States
(12) Patent Application Publication
(10) Pub. No.: US 2003/0158931 A1
(43) Pub. Date: Aug. 21, 2003

(54) Information equipment management system

(75) Inventors: Yasuhiko Nishimuta, Kurume-shi (JP); Masakatsu Matsuo, Munakata-gun (JP); Hiroyuki Tanaka, Kurume-shi (JP); Hiroshi Tomishige, Chikushino-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 10/358,584

(22) Filed: Feb. 5, 2003

(30) Foreign Application Priority Data
Feb. 7, 2002 (JP) P. 2002-030532
Dec. 20, 2002 (JP) P. 2002-370321

(51) Int. Cl. G06F 15/173

(52) U.S. Cl. 709/223; 709/202

(57) ABSTRACT

An information equipment management system has information equipment 100 and a management computer 200 for managing the information equipment by collecting equipment information about the information equipment 100. The information equipment 100 has an equipment information storage section 101 for retaining equipment information; an equipment information transmission section 102 for establishing communication with the management computer 200; and an equipment information transmission control section 103 for periodically transmitting the equipment information to the management computer 200. The management computer 200 has an equipment information receiving section 201 for receiving equipment information transmitted from the equipment information transmission section 102; an equipment information storage section 202 for storing the transmitted equipment information; and an equipment information analysis section 201 for analyzing a cause of a failure on the basis of the equipment information stored in the equipment information storage section 202 in the event of occurrence of the failure.

### BACKGROUND OF THE INVENTION

The invention relates to an information equipment management system having information equipment and a management computer for collecting and managing information about the information equipment.

Conventional information equipment to be managed by a management computer has the function of reporting a failure to a specified location in the event of occurrence of a failure.

Here, the conventional information equipment system will be described with reference to FIGS. 8 and 9.

FIG. 8 is a block diagram showing the conventional information equipment system, and FIG. 9 is a flowchart showing operation of an equipment information transmission control section of the information equipment system shown in FIG. 8.

As shown in FIG. 8, the information equipment management system comprises information equipment 100 and a management computer 200 for collecting and managing equipment information about the information equipment 100.

The information equipment 100 has an equipment information storage section 101 for retaining equipment information; an equipment information transmission section 102 for establishing communication with the management computer 200 by way of a (wired/wireless) network N; and an equipment information transmission control section 103 for transmitting equipment information to the management computer 200 in the event of occurrence of a failure. The management computer 200 has an equipment information receiving section 201 for receiving equipment information transmitted from the equipment information transmission section 102; and an equipment information storage section 202 for saving the thus-transmitted equipment information in the form of a database.

Operation of the information equipment management system of such a configuration will now be described by reference to FIG. 9.

Upon detection of a failure in the information equipment 100 (S20), the equipment information transmission control section 103 of the information equipment 100 transmits the information stored in the equipment information storage section 101 to the management computer 200 by utilization of the equipment information transmission section 102 (S21). The management computer 200 receives the transmitted equipment information by utilization of the equipment information receiving section 201.

As a result, occurrence of a failure in the information equipment 100 is reported to the management computer 200.

Additionally, it is known that contents of failure caused in the copying machine and an order of the failures are stored in the microcomputer so that a cause of the failures maybe easily estimated (for example, see JP-A-62-90668).

Furthermore, it is known that when malfunction or failure is caused in the electrophotographic apparatus, malfunction status or error status information is sent to the host computer. In combination the intrinsic information of the electrophotographic apparatus and the status information, a cause of the failure and a countermeasure thereto are estimated (see JP-A-9-30092).

Equipment information to be transmitted from the information equipment in the event of occurrence of a failure in the equipment enables ascertainment of a failure occurrence phenomenon pertaining to occurrence of a failure in information equipment but poses difficulty in elucidating a cause responsible for occurrence of the failure.

In the event that a failure has arisen in the information equipment, the information equipment management system is required to quickly elucidate the cause of the failure and to take immediate countermeasures against the cause.

### SUMMARY OF THE INVENTION

Accordingly, the invention is aimed at providing an information equipment management system which enables elucidation of a cause of a failure having arisen in information equipment.

To solve the problem, the invention provides an information equipment management system having information equipment and a management computer for managing the information equipment by collecting equipment information about the information equipment, wherein the information equipment has an equipment information storage section for retaining equipment information, an equipment information transmission section for establishing communication with the management computer, and an equipment information transmission control section for periodically transmitting the equipment information to the management computer; and the management computer has an equipment information receiving section for receiving the equipment information transmitted from the equipment information transmission section, an equipment information storage section for storing the transmitted equipment information, and an equipment information analysis section for analyzing a cause of a failure on the basis of the equipment information stored in the equipment information storage section in the event of occurrence of the failure.

As mentioned above, equipment information about the information equipment is periodically transmitted to the management computer, and the information is stored in the equipment information storage section. In the event of occurrence of a failure in the information equipment, the equipment information analysis section analyzes a cause of the failure on the basis of the equipment information stored in the equipment information storage section. Hence, occurrence of a failure in information equipment and a cause responsible for occurrence of the failure can be elucidated.

### BRIEF DESCRIPTION OF THE DRAWINGS

FIG. 1 is a block diagram showing an information equipment management system according to a first embodiment of the invention;

FIG. 2 is a descriptive view showing a positional relationship between information equipment and a management computer in the information equipment management system shown in FIG. 1;

FIG. 3 is a flowchart showing operation of an equipment information transmission control section of the information equipment management system shown in FIG. 1;

FIG. 4 is a block diagram showing an information equipment management system according to a second embodiment of the invention;

FIG. 5 is a descriptive view showing a positional relationship between information equipment and a management computer in the information equipment management system shown in FIG. 4;

FIG. 6 is a block diagram showing an information equipment management system according to a third embodiment of the invention;

FIG. 7 is a descriptive view showing a positional relationship between information equipment and a management computer in the information equipment management system shown in FIG. 6;

FIG. 8 is a block diagram showing a related-art information equipment management system;

FIG. 9 is a flowchart showing operation of an equipment information transmission control section in the information equipment management system shown in FIG. 8; and

FIG. 10 is a flowchart showing an analysis method to be employed in an information equipment analysis section.

### DETAILED DESCRIPTION OF THE PREFERRED EMBODIMENTS

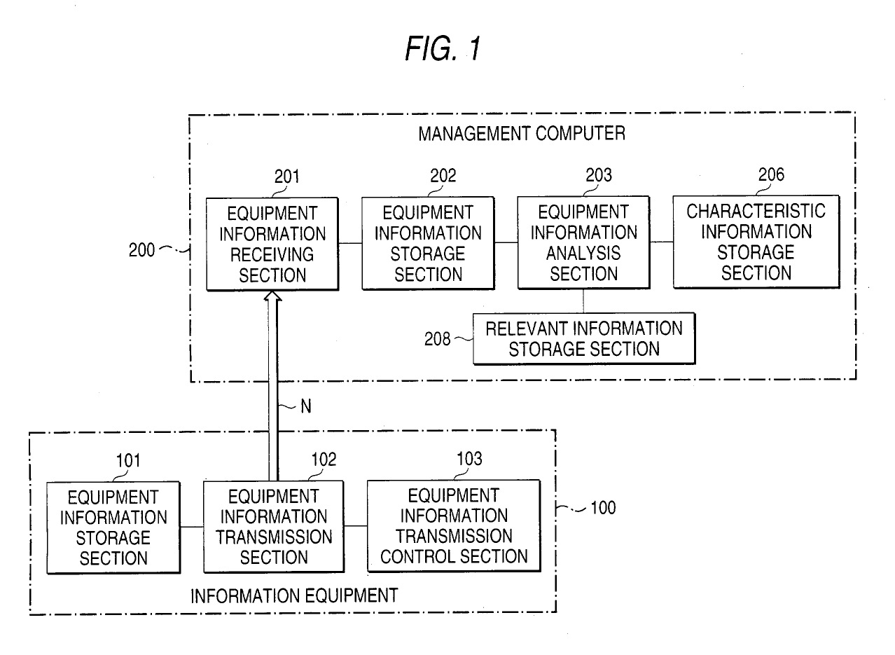

Embodiments of the invention will be described hereinbelow by reference to FIGS. 1 through 7 and 10. Throughout the drawings, like elements are assigned like reference numerals, and their repeated explanations are omitted.

(First Embodiment)

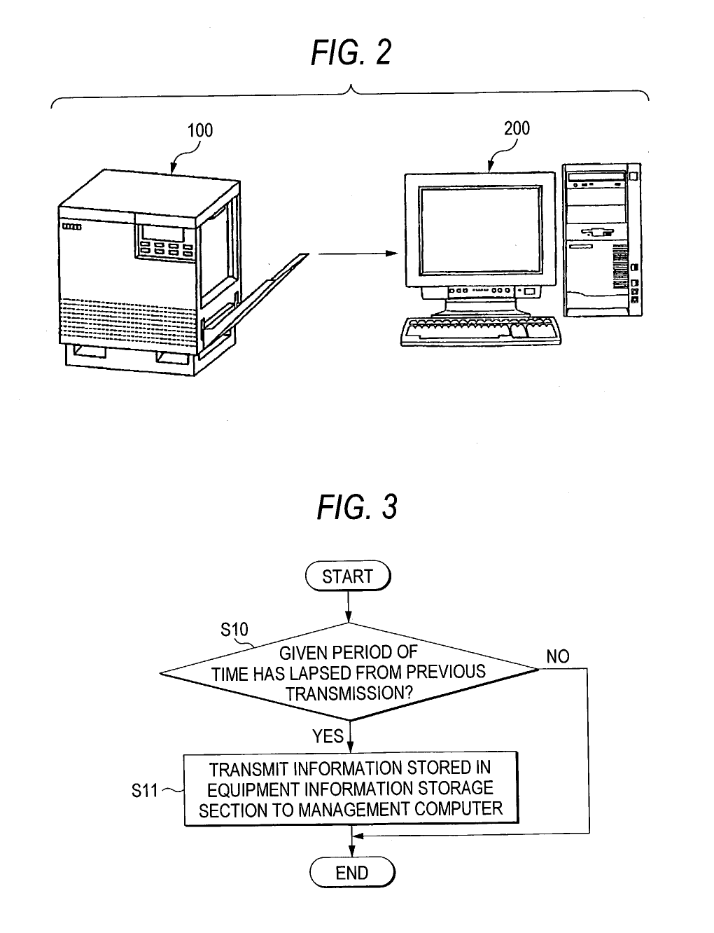

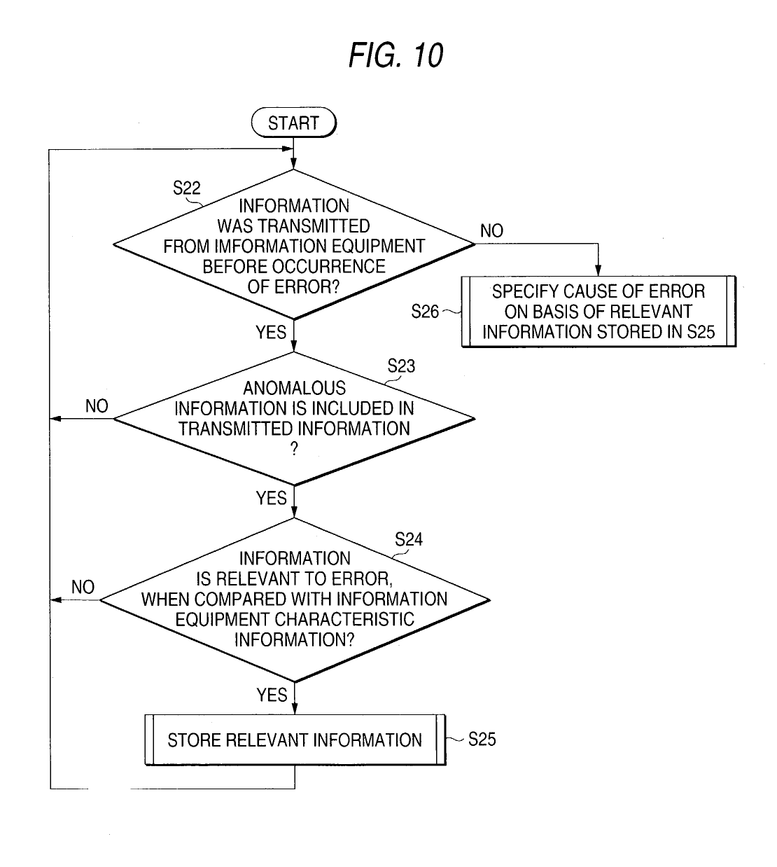

FIG. 1 is a block diagram showing an information equipment management system according to a first embodiment of the invention. FIG. 2 is a descriptive view showing a positional relationship between information equipment and a management computer, both belonging to the information equipment management system shown in FIG. 1. FIG. 3 is a flowchart showing operation of an equipment information transmission control section provided in the information equipment management system shown in FIG. 1. FIG. 10 is a flowchart showing an analysis method to be employed in an information equipment analysis section.

As shown in FIGS. 1 and 2, the equipment information management system comprises information equipment 100; e.g., a facsimile or a printer, and a management computer for collecting and managing equipment information about the information equipment 100.

The information equipment 100 has an equipment information storage section 101 which is formed from RAM or a hard disk drive and stores equipment information; an equipment information transmission section 102 for establishing communication with the management computer 200 byway of a (wired/wireless) network N; and an equipment information transmission control section 103 for periodically transmitting equipment information to the management computer, for example, every hour. Although in the embodiment the equipment information is described as being transmitted hourly, the information may be transmitted every two hours or every day, for example. The management computer 200 has an equipment information receiving section 201 for receiving the equipment information transmitted from the equipment information transmission section 102; an equipment information storage section 202 which stores the transmitted equipment information in the form of a database and is formed from a hard disk drive; and an equipment information analysis section 203 for analyzing a cause of a failure on the basis of equipment information of the past stored in the equipment information storage section 202 in the event of occurrence of a failure. Additionally, the management computer 200 further includes a characteristic information storage section 206 which stores information equipment characteristic information and a relevant information storage section 208 which stores relevant information with respect to a failure.

Operation of the information equipment management system having such a configuration will now be described by reference to FIG. 3.

After lapse of a given period of time from previous transmission of equipment information; e.g., an hour in the embodiment (S10), the equipment information transmission control section 103 of the information equipment 100 transmits the equipment information stored in the equipment information storage section 101 to the management computer 200 by utilization of the equipment information transmission section 102 (S11). The management computer 200 receives the thus-transmitted equipment information by utilization of the equipment information receiving section 201 and stores the thus-received information in the equipment information storage section 202.

As mentioned above, when equipment information including information about occurrence of a failure in the information equipment 100 is transmitted in a state in which the equipment information about the information equipment 100 is transmitted to the management computer 200 every hour, the equipment information analysis section 203 analyzes a cause responsible for a current error on the basis of all data sets pertaining to equipment information of the past stored in the equipment information storage section 202, such as one-hour-old information or two-hour-old information.

A further explanation will now be given by taking, as an example, a case in which the information equipment 100 has reported an error stating “Breakage of a component A.” It is assumed that a paper jam has frequently arisen in the information equipment 100 for reasons of a failure in a component B and a failure in a component C and that a user of the information equipment 100 has erroneously broken a component A of the information equipment while attempting to eliminate a paper jam.

Under normal conditions, when an error message stating “Breakage of a component A” has appeared, the user replaces the component A with a new one. However, this reaction is not a fundamental countermeasure against the foregoing case; a paper jam will arise for reasons of the failure in the component B and a failure in the component C.

According to the embodiment, as can be seen from the flowchart shown in FIG. 10, the equipment information analysis section 203 determines whether or not the equipment information was transmitted from the information equipment 100 immediately before occurrence of the error stored in the equipment information storage section 202 (S22).

The equipment information analysis section 203 determines whether or not anomalous equipment information is included in the transmitted equipment information (S23).

Next, when anomalous equipment information (i.e., occurrence of a paper jam) is determined to be included, the anomalous equipment information (paper jam) transmitted from the information equipment 100 is compared with information equipment characteristic information (which will be described in detail later) previously stored in the characteristic information storage section 206 of the management computer 200, the information storage section being a hard disk drive. A determination is then made as to whether or not the anomalous equipment information (paper jam) is relevant to breakage of the component A (S24).

Here, the previously-stored information equipment characteristic information signifies characteristic information unique to the information equipment 100 and includes characteristic information; for instance, “a paper jam will arise in the event a failure has arisen in the components B and C” and another piece of characteristic information stating that “the component A must be removed for eliminating a paper jam.”

In S24, the equipment information analysis section 203 determines that the information about a paper jam is relevant to breakage of the component A. A result of determination is stored in the relevant information storage section 208 provided in the management computer 200 (S25).

When no anomalous information is determined to be included in S23 or when in S24 breakage of the component A is determined not to be relevant to the anomalous information detected in S23, processing returns to S22. The above-described operations are repeated with regard to all pieces of equipment information transmitted from the information equipment 100.

In the embodiment, a paper jam frequently arises in the information equipment 100. In this case, the equipment information analysis section 203 determines again and again that a paper jam is relevant to the breakage of the component A. In S25, determination results (that is, a plurality of data sets stating that a paper jam is relevant to the breakage of the component A) are stored in the management computer 200.

In this way, when rendering of a determination has been completed with regard to all the information pieces stored in the equipment information storage section 202, processing proceeds to S26.

Since a result of determination stating “a paper jam is relevant to the breakage of the component A” has been stored many times in S25, the equipment information analysis section 203 displays on the management computer 200 a cause responsible for breakage of the component A as “a failure in the component B and a failure in the component C.”

Specifically, a determination is made on the basis of frequent occurrence of a paper jam, thereby indicating a possibility of breakage of the component A and leading to a conclusion that the components B and C are also responsible for a paper jam.

If in S26 no data are determined to be stored in S25, this determination signifies that “no anomalous information is determined to be found in S23” or that, “although anomalous information has been determined in S24, comparison with the information equipment characteristic information has determined that the information is not relevant to an error “Breakage of the component A.” Hence, “Breakage of the component A” is displayed on the management computer 200 as a cause of the breakage of the component A.

Although omitted from FIG. 10, all the information stored in the equipment information storage section 202 is cleared at the time of replacement of the broken component A, and equipment information obtained after replacement is newly accumulated at given intervals.

As mentioned above, according to the embodiment, equipment information is acquired and stored at given intervals. In the event that a failure has arisen in a component, a cause of the failure is analyzed on the basis of all of the pieces of stored equipment information and the previously-stored characteristic information unique to the information equipment 100. Immediate and appropriate analysis of a cause of the failure becomes feasible.

In the embodiment, in the event of occurrence of a failure in a component, a cause of the failure is analyzed on the basis of all pieces of stored equipment information and the previously-stored characteristic information unique to the information equipment 100. As a modification of this embodiment, a cause of the failure may be analyzed on the basis of, e.g., all pieces of anomalous information pertaining to a paper jam and the previously-stored characteristic information unique to the information equipment 100.

Alternatively, the information equipment 100 of the embodiment is arranged to automatically and periodically transmit equipment information to the management computer 200. However, the invention is not limited to such a modification. The management computer 200 may be arranged to periodically inquire of the information equipment 100 about equipment information.

Moreover, the management computer 200 may be integrally built into the information equipment 100.

As mentioned above, according to the embodiment, equipment information about the information equipment 100 is periodically transmitted to the administrative computer 200, and the thus-transmitted information is stored in the equipment information storage section 202. In the event that a failure has arisen in the information equipment 100, the equipment information analysis section 203 analyzes a cause of the failure on the basis of the equipment information stored in the equipment information storage section 202. Hence, in addition to occurrence of a failure in the information equipment 100, a failure responsible for occurrence of the failure can be elucidated.

As a result, it becomes possible to quickly elucidate a cause of a failure in the event of occurrence of failure in the information equipment 100; to take early measures against the failure; and to provide feedback for elucidating causes of future failures.

The information equipment 100 periodically provides the administrative computer 200 with equipment information. Hence, information about consumable items of the information equipment 100 can be ascertained. For instance, automatic placement of an order for consumable items can be effected, thus improving service.

(Second Embodiment)

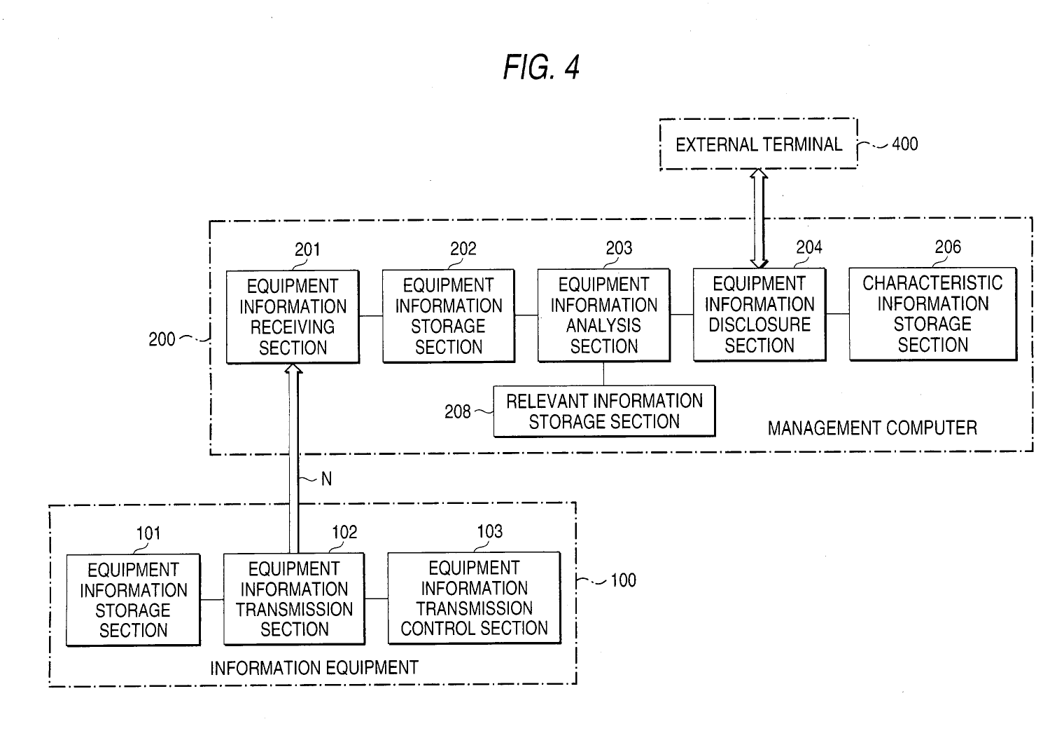

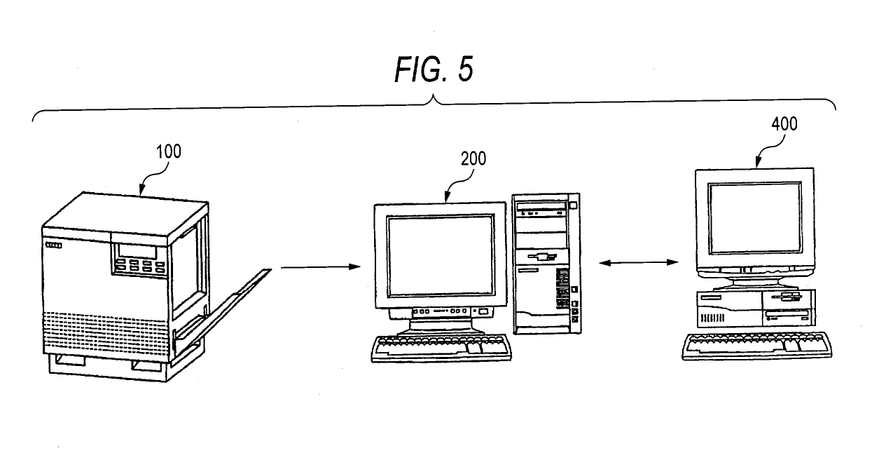

FIG. 4 is a block diagram showing an information equipment management system according to a second embodiment of the invention. FIG. 5 is a descriptive view showing a positional relationship between information equipment and a management computer in the information equipment management system shown in FIG. 4.

Basic operation of the information equipment management system, including that of an information equipment management system according to a third embodiment which will be described later, is identical with that of the information equipment management system of the first embodiment.

As shown in FIGS. 4 and 5, the equipment information management system comprises the information equipment 100, the management computer 200, and an external terminal 400 capable of browsing equipment information about the management computer 200.

In addition to having the equipment information receiving section 201, the equipment information storage section 202, and the equipment information analysis section 203, the management computer 200 has an equipment information disclosure section 204 which renders equipment information stored in the equipment information storage section 202 browsable by disclosing the information on the external terminal 400.

As a result of the equipment information being disclosed to the external terminal 400, the information equipment management system can be utilized by use of, e.g., a WEB browser by way of the external terminal 400.

(Third Embodiment)

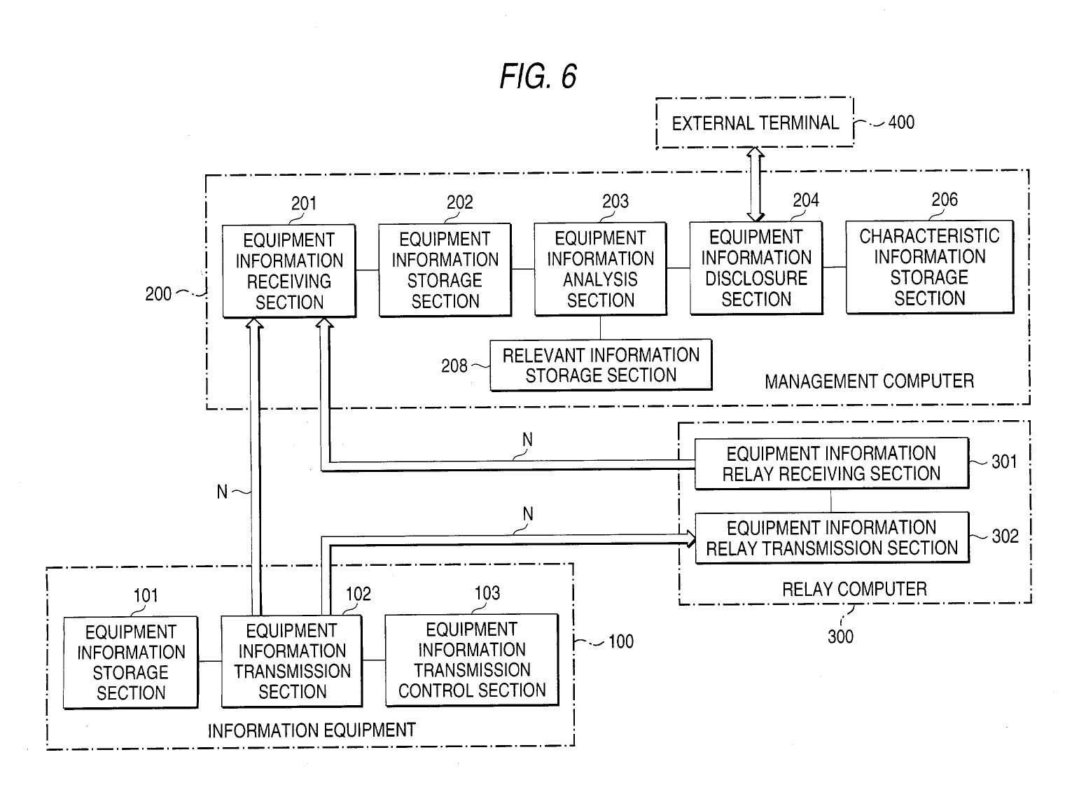

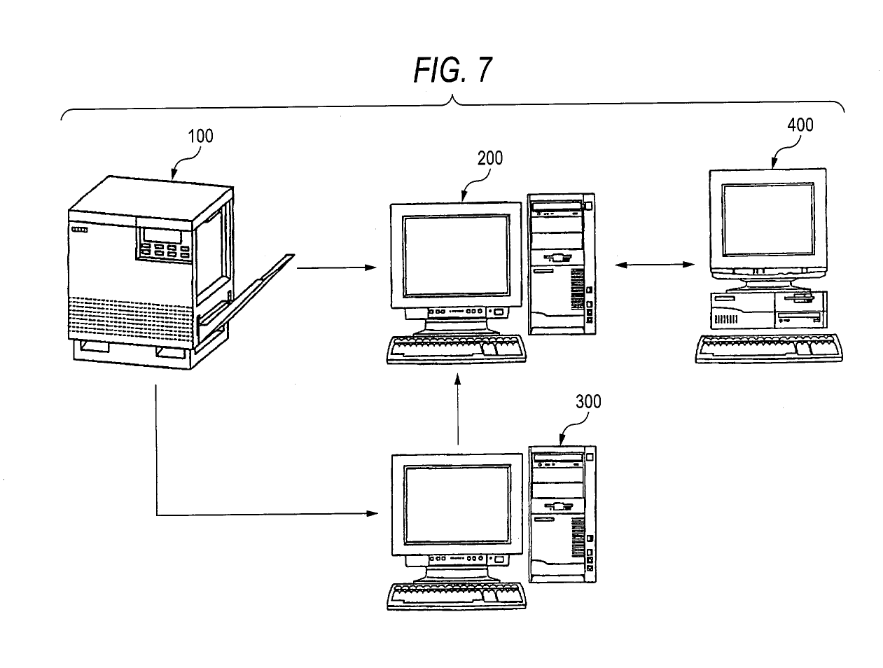

FIG. 6 is a block diagram showing an information equipment management system according to a third embodiment of the invention. FIG. 7 is a descriptive view showing a positional relationship between information equipment and a management computer in the information equipment management system shown in FIG. 6.

As shown in FIGS. 6 and 7, the equipment information management system comprises information equipment 100; a management computer 200; an external terminal 400; and a relay computer 300.

The relay computer 300 comprises an equipment information relay receiving section 301 for receiving equipment information transmitted from the information equipment 100; and an information transmission section 302 for transmitting the equipment information received by the equipment information relay receiving section 301 to the management computer 200.

Such an information equipment management system enables collection of equipment information about the information equipment 100 installed at a remote location, thereby enabling construction of an information equipment management system corresponding to a large-scale network.

The information equipment management system of the third embodiment is provided with the external terminal 400 and an equipment information disclosure section 204 for disclosing equipment information to the external terminal 400. However, these elements may be omitted.

As has been described, according to the invention, equipment information about information equipment is periodically transmitted to a management computer, and the information is stored in an equipment information storage section. In the event of occurrence of a failure in the information equipment, an equipment information analysis section analyzes a cause of the failure on the basis of the equipment information stored in the equipment information storage section. Hence, there is yielded an effective advantage of the ability to elucidate a cause of a failure having arisen in the information equipment.

Since the information equipment periodically provides the management computer with equipment information, the equipment information is tracked, to thereby yield an effective advantage of the ability to improve service.

If the information equipment management system is provided with an equipment information disclosure section for disclosing equipment information stored in an equipment information storage section to an external terminal, there is yielded an effective advantage of the ability to utilize the information equipment management system by way of the external terminal.

If the information equipment management system is provided with a relay computer, the computer having an information receiving section for receiving equipment information transmitted from information equipment and an information transmission section for transmitting the equipment information received by the information receiving section to the management computer, collection of equipment information about information equipment installed at a remote location becomes feasible, thereby yielding an effective advantage of the ability to construct an information equipment management system corresponding to a large-scale network.

[FIG 1]

100 INFORMATION EQUIPMENT

101 EQUIPMENT INFORMATION STORAGE SECTION

102 EQUIPMENT INFORMATION TRANSMISSION SECTION

103 EQUIPMENT INFORMATION TRANSMISSION CONTROL SECTION

200 MANAGEMENT COMPUTER

201 EQUIPMENT INFORMATION RECEIVING SECTION

202 EQUIPMENT INFORMATION STORAGE SECTION

203 EQUIPMENT INFORAMTION ANALYSIS SECTION

206 CHARACTERISTIC INFORMATION STORAGE SECTION

208 RELEVANT INFORMATION STORAGE SECTION

[FIG 3]1

START

S10 HAS GIVEN PERIOD OF TIME LAPSED FROM PREVIOUS TRANSMISSION?

S11 TRANSMIT INFORMATION STORED IN EQUIPMENT INFORMTION STORAGE SECTION TO MANAGEMENT COMPUTER

END

[FIG. 4]

100 INFORMATION EQUIPMENT

101 EQUIPMENT INFORMATION STORAGE SECTION

102 EQUIPMENT INFORMATION TRANSMISSION SECTION

103 EQUIPMENT INFORMATION TRANSMISSION CONTROL SECTION

200 MANAGEMENT COMPUTER

201 EQUIPMENT INFORMATION RECEIVING SECTION

202 EQUIPMENT INFORMATION STORAGE SECTION

203 EQUIPMENT INFORMATION ANALYSIS SECTION

204 EQUIPMENT INFORMATION DISCLOSURE SECTION

206 CHARACTERISTIC INFORAMTION STORAGE SECTION

208 RELEVANT INFORMATION STORAGE SECTION

400 EXTERNAL TERMINAL

FIG. 6

100 INFORMATION EQUIPMENT

101 EQUIPMENT INFORMATION STORAGE SECTION

102 EQUIPMENT INFORMATION TRANSMISSION SECTION

103 EQUIPMENT INFORMATION TRANSMISSION CONTROL SECTION

200 MANAGEMENT COMPUTER

201 EQUIPMENT INFORMATION RECEIVING SECTION

202 EQUIPMENT INFORMATION STORAGE SECTION

203 EQUIPMENT INFORMATION ANALYSIS SECTION

204 EQUIPMENT INFORMATION DISCLOSURE SECTION

206 CHARACTERISTIC INFORMATION STORAGE SECTION

208 RELEVANT INFORMATION STORAGE SECTION

400 EXTERNAL TERMINAL

300 RELAY COMPUTER

301 EQUIPMENT INFORMATION RELAY RECEIVING SECTION

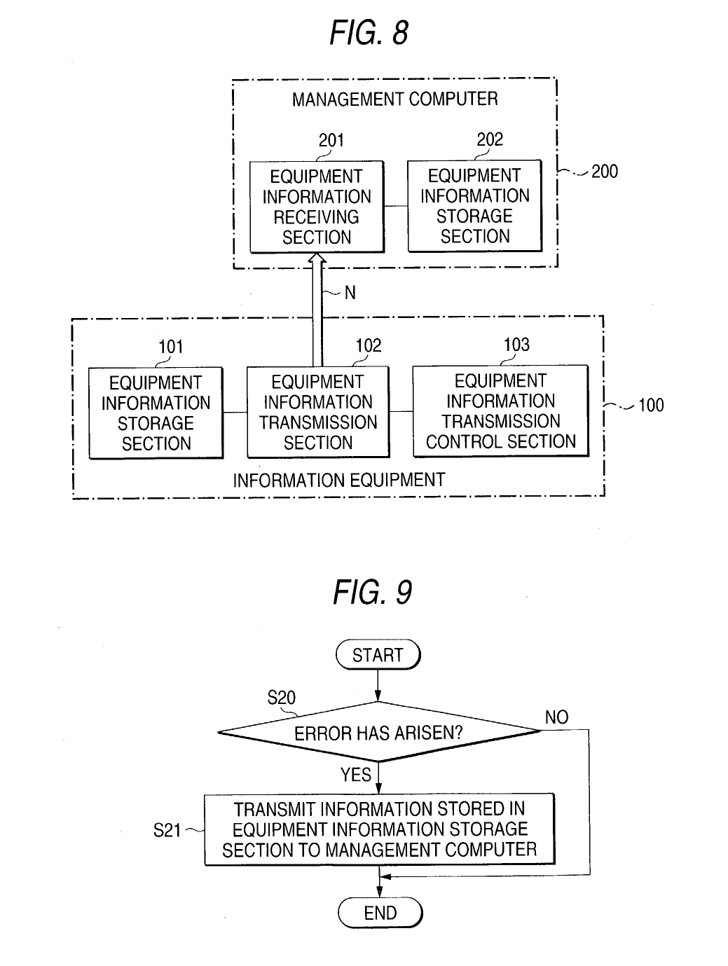

302 EQUIPMENT INFORMATION RELAY TRANSMISSION SECTION

[FIG 8]

100 INFORMATION EQUIPMENT

101 EQUIPMENT INFORMATION STORAGE SECTION

102 EQUIPMENT INFORMATION TRANSMISSION SECTION

103 EQUIPMENT INFORMATION TRANSMISSION CONTROL SECTION

200 MANAGEMENT COMPUTER

201 EQUIPMENT INFORMATION RECEIVING SECTION

202 EQUIPMENT INFORMATION STORAGE SECTION

[FIG 9]

START

S20 HAS AN ERROR ARISEN?

S21 TRANSMIT INFORMATION STORED IN EQUIPMENT INFORMATION STORAGE SECTION TO MANAGEMENT COMPUTER

END

[FIG. 10]

START

S22 WAS INFORMATION TRANSMITTED FROM INFORMATION EQUIPMENT BEFORE OCCURRENCE OF THE ERROR?

S23 IS ANOMALOUS INFORMATION INCLUDED IN TRANSMITTED INFORMATION?

S24 IS THE INFORMATION RELEVANT TO THE ERROR, WHEN COMPARED WITH INFORMATION EQUIPMENT CHARACTERISTIC INFORMATION?

S25 STORE RELEVANT INFORMATION.

S26 SPECIFY CAUSE OF ERROR ON THE BASIS OF RELEVANT INFORMATION STORED IN S25.

What is claimed is:

1. An information equipment management system comprising an information equipment and a management computer for managing the information equipment by collecting equipment information about the information equipment, wherein
said information equipment includes:
an equipment information storage section for retaining equipment information;
an equipment information transmission section for establishing communication with the management computer; and
an equipment information transmission control section for periodically transmitting the equipment information to the management computer; and
said management computer includes:
an equipment information receiving section for receiving equipment information transmitted from the equipment information transmission section;
an equipment information storage section for storing the transmitted equipment information; and
an equipment information analysis section for analyzing a cause of a failure on the basis of the equipment information stored in the equipment information storage section in the event of occurrence of the failure.

2. The information equipment management system according to claim 1, wherein the management computer has an equipment information disclosure section for disclosing the equipment information stored in the equipment information storage section to an external terminal.

3. The information equipment management system according to claim 1, further comprising a relay computer which includes an information receiving section for receiving the equipment information transmitted from the information equipment and an information transmission section for transmitting the equipment information received by the information receiving section to the management computer.

4. The information equipment management system according to claim 2, further comprising a relay computer which includes an information receiving section for receiving the equipment information transmitted from the information equipment and an information transmission section for transmitting the equipment information received by the information receiving section to the management computer.

5. An apparatus for determining a cause of an anomaly having arisen in information equipment, comprising:
an equipment information receiving section for receiving equipment information about information equipment at predetermined intervals;
an equipment information storage section for cumulatively storing the received equipment information;
a characteristic information storage section for storing a characteristic information of the information equipment; and
an equipment information analysis section which determines whether or not anomalous information is included in a plurality of pieces of equipment information cumulatively stored in the equipment information storage section and compares the anomalous information in the plurality of pieces of equipment information with a characteristic information of the information equipment stored in the characteristic information storage section, thereby analyzing a cause of the anomaly in the information equipment.

6. The apparatus according to claim 5, wherein the anomaly cause determination apparatus erases the equipment information cumulatively stored in the equipment information storage section when the cause of the anomaly in the equipment information is eliminated.

7. The apparatus according to claim 5, wherein the equipment information analysis section compares all anomalous information pieces in the plurality of pieces of equipment information cumulatively stored in the equipment information storage section with the characteristic of the equipment information.

8. The apparatus according to claim 6, wherein the equipment information analysis section compares all anomalous information pieces in the plurality of pieces of equipment information cumulatively stored in the equipment information storage section with the characteristic of the equipment information.

9. A method for determining a cause of an anomaly in information equipment, comprising:
a first step of receiving equipment information about information equipment at predetermined intervals;
a second step of determining whether or not anomalous information is included in all pieces of equipment information received in the first step; and
a third step of comparing the anomalous information determined in the second step with a characteristic information of the information equipment, thereby estimating a cause of the failure in the information equipment.

10. The method according to claim 9, wherein, in the second step, the determination is performed with regard to only the equipment information from which the cause of the failure in the equipment information has been eliminated.

11. The method according to claim 9, wherein, in the third step, all pieces of information equipment determined to be anomalous in the second step are compared with the characteristic of the equipment information.

12. The method according to claim 10, wherein, in the third step, all pieces of information equipment determined to be anomalous in the second step are compared with the characteristic of the equipment information.
